(19) United States
(12) Patent Application Publication
(10) Pub. No.: US 2009/0003412 A1
(43) Pub. Date: Jan. 1, 2009

(54) SPREAD SPECTRUM RADAR APPARATUS

(75) Inventors: Noboru NEGORO, Osaka (JP); Takeshi FUKUDA, Osaka (JP); Hiroyuki SAKAI, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/038,198

(22) Filed: Feb. 27, 2008

(30) Foreign Application Priority Data
Mar. 2, 2007 (JP) 2007-053397

(51) Int. Cl. H04B 1/69

(52) U.S. Cl. 375/130; 375/E01.001

(57) ABSTRACT

To provide a spread spectrum radar apparatus which can lower the probability for misidentifying a presence of object. The spread spectrum radar apparatus includes: a pseudo-noise code for transmission generation unit which generates a pseudo-noise code for transmission; a spread spectrum modulation unit which performs spread spectrum modulation on a carrier wave using the pseudo-noise code for transmission; a pseudo-noise code for receiver generation unit which generates a pseudo-noise code for receiver which is a time-delayed pseudo-noise code for transmission; a spread spectrum demodulation unit which performs spread spectrum demodulation on a received signal, using the pseudo-noise code for receiver, so as to output a correlation signal; a code change control unit which changes the pseudo-noise codes for transmission and receiver into a different kind of the pseudo-noise codes at every predetermined time; and a correlation value calculation unit which averages or integrates, with the number of kinds of the generated pseudo-noise codes, an intensity of the correlation signal.

### BACKGROUND OF THE INVENTION

(1) Field of the Invention

The present invention relates to spread spectrum radar apparatuses using a spread spectrum scheme and, in particular, to a spread spectrum radar apparatus which can suppress an alias signal generated other than a received signal from a target.

(2) Description of the Related Art

In recent years, techniques relating to spread spectrum radar apparatuses using a spread spectrum scheme have been variously proposed (for example, refer to Japanese Unexamined Patent Application Laid-Open Publication No. 2955789).

The spread spectrum radar apparatus generates a broad-band signal by performing spread spectrum modulation on a narrow-band signal using a pseudo-noise code for transmission. The broad-band signal obtained by the spread spectrum modulation is transmitted as a radar wave. A reflected wave obtained through reflection of the transmitted radar wave off an object is received as a received signal. A correlation signal is generated by performing spread spectrum demodulation on the received signal using a pseudo-noise code for receiver. A presence or absence of the object, a distance to the object, a relative speed to the object, and so on, are calculated based on the correlation signal obtained by the spread spectrum demodulation. Here, a pseudo-noise code for transmission is, for example, a pseudo-noise code such as an M-sequence code and Gold-sequence code. Here, as an example, an M-sequence code with a superior autocorrelation property is assumed. Furthermore, the pseudo-noise code for receiver is a pseudo-noise code which is a time-delayed pseudo-noise code for transmission. That is to say, the pseudo-noise code for receiver is a pseudo-noise code which is delayed for the predetermined number of chips or a time smaller than chip width (hereinafter, the chip width is a time equivalent to one chip) with respect to the pseudo-noise code for transmission. Here, for the sake of making a description brief, a pseudo-noise code for receiver which is delayed for each time equivalent to one chip is used for the description. Moreover, the time delay is described simply using the following expression: a phase of code is shifted.

Next, a detection principle of the spread spectrum radar apparatus shall be described.

FIG. 1 is a diagram showing a brief overview of the detection principle of a conventional spread spectrum radar apparatus. As shown in FIG. 1, here, as an example, a scan range (distance that allows object detection) is assumed to be 1.5 to 150 meters, and resolution (the smallest measurement unit) is assumed to be 1.5 meters. In this case, in order to cover the scan range, the spread spectrum radar apparatus generates a pseudo-noise code for receiver while shifting, in ascending order, a phase from the 1^{st} to 100^{th} chip with respect to a pseudo-noise code for transmission 11. Then, as in a pseudo-noise code for receiver 16, after being shifted to the 100^{th} chip, the phase is moved back to the beginning. The spread spectrum radar apparatus generates the pseudo-noise code for receiver while shifting the phase from the 1^{st} to 100^{th} chip in ascending order again. Here, a period until when the phase is returned to the initial state again while being shifted, in ascending order, from the 1^{st} to 100^{th} chip, which is equivalent to the scan range, is assumed to be one scan cycle. Further, an update time for the spread spectrum radar apparatus is a period defined by a time equal to or more than a scan cycle. This is determined by a specification of the radar apparatus.

Specifically, the spread spectrum radar apparatus generates the pseudo-noise code for receiver while shifting the phase by one chip at a time with respect to the pseudo-noise code for transmission 11. Correlation between the generated pseudo-noise code for receiver and a received signal 13 is defined. When a phase of the generated pseudo-noise code for receiver and a phase of the received signal 13 match, that is, a delay time matches, a peak appears in a correlation signal obtained by defining the correlation. On the other hand, when these phases do not match, the peak does not appear in the correlation signal. Hereinafter, in the case where the phases match, this is called a synchronized state, and in the case where the phases do not match, this is called an asynchronous state.

For example, when the correlation between a pseudo-noise code for receiver 14 and the received signal 13 is defined, the peak does not appear in the correlation signal since it is in the asynchronous state. When the correlation between a pseudo-noise code for receiver 15 and the received signal 13 is defined, the peak appears in the correlation signal since it is in the synchronized state. Here, the pseudo-noise code for receiver 14 is a pseudo-noise code for receiver whose phase is shifted by only one chip with respect to the pseudo-noise code for transmission 11. The pseudo-noise code for receiver 15 is a pseudo-noise code for receiver whose phase is shifted by the predetermined number of chips with respect to the pseudo-noise code for transmission 11.

FIG. 2 is a diagram showing a brief overview of the correlation signal obtained by the spread spectrum modulation in the spread spectrum radar apparatus. As shown in FIG. 2, when the phases match (the synchronized state), the peak appears in the correlation signal. When the phases do not match (the asynchronous state), the peak does not appear in the correlation signal. In addition, in the case where there is one object, one peak appears during one scan period, and in the case where there are plural objects, plural peaks appear. Thus, an object can be detected by detecting a peak from the received reflected wave (graph 21 in FIG. 2).

As stated above, the spread spectrum radar apparatus specifies the number of chips equivalent to a phase shift amount which is shifted between a transmission signal 12 and the received signal 13, using the pseudo-noise code for transmission 11 and the pseudo-noise code for receiver 15. It is possible to specify a delay time equivalent to the specified phase shift amount (specified number of chips). Further, it is possible to calculate a distance to the object corresponding to the specified delay time. Here, the transmission signal 12 is a radar wave transmitted from the spread spectrum radar apparatus. The received signal 13 is a reflected wave obtained through reflection of the radar wave off the object. The delay time is equivalent to a difference between a transmission time for the radar wave and a received time of the reflected wave.

Japanese Unexamined Patent Application Laid-Open Publication No. 2955789 discloses the radar apparatus using the spread spectrum scheme. With the radar apparatus described in the above-mentioned reference, it is possible to calculate a distance to a target using the above-mentioned method. Further, in order to avoid interference from other vehicles when the radar apparatus is mounted on a vehicle, a code setting unit is provided so as to set different pseudo-noise codes for each apparatus. The code setting unit, for example, prepares, in advance, ten kinds of the pseudo-noise codes in a code generation unit which generates pseudo-noise codes for transmission and receiver. By determining, for each vehicle according to a serial number of the radar apparatus, code assignment in a fabrication stage so that one kind of the code out of the ten kinds of the codes can be set, it is possible to reduce the interference with other vehicles using the code assigned to each radar apparatus.

However, nonlinear characteristics of devices making up of the spread spectrum radar apparatus, reflection by signal propagation among wirings, reflection by matching gap, and so on, may cause the peak (spurious object) to appear at a location where it does not appear in principle (graph 22 in FIG. 2). As such an example, an alias signal other than the received signal may appear in the correlation signal. The alias signal causes a phenomenon that an object, though not present, may seem to be present. Further, the alias signal causing this phenomenon appears at a different location when the pseudo-noise code is changed. For this reason, even when the pseudo-noise code is assigned to each vehicle as described in Patent Reference 1, since the alias signal appears at the different location for each code, it is impossible to suppress a spurious object. As a result, there is a problem that a probability for misidentifying a presence of object increases.

### SUMMARY OF THE INVENTION

The present invention has been devised in view of the above-mentioned problem and has an object of providing the spread spectrum radar apparatus which can suppress the alias signal causing the spurious object and reduce the probability for misidentifying the presence of object.

In order to achieve the above object, the spread spectrum radar apparatus according to the present invention is a spread spectrum radar apparatus which detects an object by transmitting and receiving a spread spectrum signal and which includes: a carrier wave generation unit which generates a carrier wave; a code for transmission generation unit which generates a pseudo-noise code for transmission; a spread spectrum modulation unit which performs spread spectrum modulation on the carrier wave using the pseudo-noise code for transmission; a transmission unit which transmits, as a transmission signal, the carrier wave on which the spread spectrum modulation has been performed by the spread spectrum modulation unit; a receiver unit which receives, as a received signal, a reflected wave obtained through reflection of the transmission signal off the object; a code for receiver generation unit which generates a pseudo-noise code for receiver which is a time-delayed pseudo-noise code that is of a same kind as the pseudo-noise code for transmission; a spread spectrum demodulation unit which performs spread spectrum demodulation on the received signal, using the pseudo-noise code for receiver, so as to output a correlation signal; a control unit which controls the code for transmission generation unit and the code for receiver generation unit so that the pseudo-noise code for transmission and the pseudo-noise code for receiver are changed into a different kind of pseudo-noise codes respectively at every predetermined time; and a calculation unit which averages or integrates an intensity of the correlation signal.

Here, the predetermined time is a time equal to or more than a cycle of the pseudo-noise code for receiver or the pseudo-noise code for transmission and equal to or less than half of an update time of a radar signal defined by the specification of the radar apparatus. For instance, when the update time of the radar signal is defined as one second, an upper limit of the predetermined time is 0.5 second.

In addition, in the case where the predetermined time at which the pseudo-noise code is changed is longer than a scan cycle, the calculation unit averages or integrates correlation values in one or more scans performed until the predetermined time. On the other hand, in the case where the predetermined time is shorter than the scan cycle, since the averaging or integrating of correlation values in one scan cycle is performed, data in which correlation values demodulated by plural kinds of pseudo-noise codes are mixed in one scan cycle is to be calculated.

This allows the influence of the alias signal causing the spurious object to be suppressed, which can lower the probability for misidentifying the presence of object.

Moreover, the predetermined time is time necessary for the trigger signal to be outputted one or more times. The control unit includes: a timing adjustment unit which adjusts a timing for changing the pseudo-noise code for transmission and the pseudo-noise code for receiver, by selecting the trigger signal one time at the predetermined time; and a code change instruction issuance unit which issues, to the code for transmission generation unit, the code for receiver generation unit, and the calculation unit, an instruction to change the pseudo-noise code for transmission and the pseudo-noise code for receiver into the different kind of the pseudo-noise codes respectively, at the timing adjusted by the timing adjustment unit.

Here, although the trigger signal is preferably outputted for every scan cycle, it may be outputted for every cycle of the pseudo-noise code or every time the pseudo-noise code is time-delayed. It should be noted that the cycle in which the trigger signal is outputted may satisfy the following relation: (Cycle of pseudo-noise code)≦(Cycle of trigger signal)≦(Half of update time for radar signal).

This allows, for example, the pseudo-noise code is changed into the different kind of the pseudo-noise code for every one scan cycle or plural cycles of the radar apparatus. When the pseudo-noise code is changed, the alias signal appears at the different location. The peak induced by the alias signal can be suppressed by averaging or integrating the intensity of the correlation signal with the number of kinds of the pseudo-noise codes. As a result, the alias signal causing the spurious object can be suppressed.

In addition, the control unit may control the code for transmission generation unit and the code for receiver generation unit so that the pseudo-noise code for transmission and the pseudo-noise code for receiver are changed from a first kind pseudo-noise code into a second kind pseudo-noise code having an reversed order of chips of the first kind pseudo-noise code respectively at every predetermined time.

Consequently, the different kind of the pseudo-noise code can be generated by only changing an order of reading chips included in the pseudo-noise code, which lightens loads in generating the pseudo-noise code.

Furthermore, the code for transmission generation unit may include: a sample chip sequence storage unit in which plural sample chip sequences included in the first pseudo-noise code are stored; a sample chip sequence selection unit which selects, from among the plural sample chip sequences stored in the sample chip sequence storage unit, a sample chip sequence to be read; a partial chip sequence extraction unit which extracts, from the sample chip sequence selected by the sample chip sequence selection unit, a predetermined number of chips as a partial chip sequence; an order conversion unit which changes the order of the chips in the partial chip sequence extracted by the partial chip sequence extraction unit, and to output the partial chip sequence; and a chip output unit which outputs, one at a time, the chips in the partial chip sequence outputted from the order conversion unit.

Consequently, only changing the order of reading allows the different kinds of the pseudo-noise codes to be generated without separately storing a set of the sample chip sequence for each of the pseudo-noise codes. Further, it becomes possible to output the pseudo-noise codes at high speed. Accordingly, it allows the distance resolution of the radar apparatus to be improved.

Moreover, the spread spectrum radar apparatus may include a judgment unit which judges that the object is absent in a distance equivalent to the delay time at which the intensity of the correlation signal averaged or integrated by the calculation unit is equal to or less than a predetermined threshold value, so as to prevent misidentification of a presence of the object.

This allows the influence of the alias signal causing the spurious object to be suppressed, which can lower the probability for misidentifying the presence of object.

Furthermore, the present invention can be realized not only as an apparatus but also as a misidentification prevention method for preventing the spread spectrum radar apparatus from misidentifying the object. That is to say, it is possible that the misidentification prevention method for preventing the spread spectrum radar apparatus from misidentifying an object includes steps of: generating a carrier wave; generating a pseudo-noise code for transmission; performing spread spectrum modulation on the carrier wave using the pseudo-noise code for transmission; transmitting, as a transmission signal, the carrier wave on which the spread spectrum modulation has been performed in the spreading; receiving, as a received signal, a reflected wave obtained through reflection of the transmission signal off an object; generating a pseudo-noise code for receiver which is a time-delayed pseudo-noise code that is of a same kind as the pseudo-noise code for transmission; performing spread spectrum demodulation on the received signal received in the receiving, using the pseudo-noise code for receiver, so as to output a correlation signal; controlling the generation of the pseudo-noise code for transmission in the generating the pseudo-noise code for transmission and the generation of the pseudo-noise code for receiver in the generating the pseudo-noise code for receiver so that the first pseudo-noise code for transmission and the pseudo-noise code for receiver are changed into a different kind of pseudo-noise codes respectively at every predetermined time; calculating an average or integration of an intensity of the correlation signal; and judging that the object is absent in a distance equivalent to the delay time at which the intensity of the correlation signal averaged or integrated in the calculating is equal to or less than a predetermined threshold value, so as to prevent misidentification of a presence of the object.

According to the present invention, the pseudo-noise code for transmission and the pseudo-noise code for receiver are changed into the different kind of the pseudo-noise codes, for example, for one or more scan cycles of the radar apparatus. When the pseudo-noise code is changed, the alias signal appears at the different location. The peak induced by the alias signal can be suppressed by averaging or integrating the intensity of the correlation signal with the number of kinds of the pseudo-noise codes. As a result, the alias signal causing the spurious object can be suppressed. This allows the probability for misidentifying the presence of object to be lowered, which leads to provide a spread spectrum radar apparatus with superior safety.

Further Information about Technical Background to this Application

The disclosure of Japanese Patent Application No. 2007-053397 filed on Mar. 2, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the Drawings:

FIG. 1 is a diagram showing a brief overview of the detection principle of the conventional spread spectrum radar apparatus;

FIG. 2 is a diagram showing a brief overview of the correlation signal obtained by the spread spectrum modulation in the conventional spread spectrum radar apparatus;

FIG. 3 is a diagram showing a configuration of the spread spectrum radar apparatus according to an embodiment of the present invention;

FIG. 4 is a diagram showing a configuration of the pseudo-noise code for transmission generation unit according to the embodiment of the present invention;

FIG. 5 is a diagram showing a configuration of the correlation value calculation unit according to the embodiment of the present invention;

FIG. 6 is a diagram showing an example of the configuration of the correlation value calculation unit according to the embodiment of the present invention;

FIG. 7 is a diagram showing a configuration of the code change control unit according to the embodiment of the present invention;

FIG. 8 is a diagram showing an example of the sample chip sequence stored in the sample chip sequence storage unit according to the embodiment of the present invention;

FIG. 9 is a diagram showing a situation where the alias signal causing the spurious object is suppressed in the spread spectrum radar apparatus according to the embodiment of the present invention;

FIG. 10 is a diagram showing the first kind pseudo-noise code outputted from the pseudo-noise code for transmission generation unit according to the embodiment of the present invention;

FIG. 11 is a diagram showing a flow at a time when the first kind pseudo-noise code is outputted from the pseudo-noise code for transmission generation unit according to the embodiment of the present invention;

FIG. 12 is a diagram showing the second kind pseudo-noise code outputted from the pseudo-noise code for transmission generation unit according to the embodiment of the present invention;

FIG. 13 is a diagram showing a flow at a time when the second kind pseudo-noise code is outputted from the pseudo-noise code for transmission generation unit according to the embodiment of the present invention;

FIG. 14 is a diagram showing a flow at a time when the first kind pseudo-noise code is outputted from the pseudo-noise code for transmission generation unit according to the embodiment of the present invention; and

FIG. 15 is a diagram showing a flow at a time when the second kind pseudo-noise code is outputted from the pseudo-noise code for transmission generation unit according to the embodiment of the present invention.

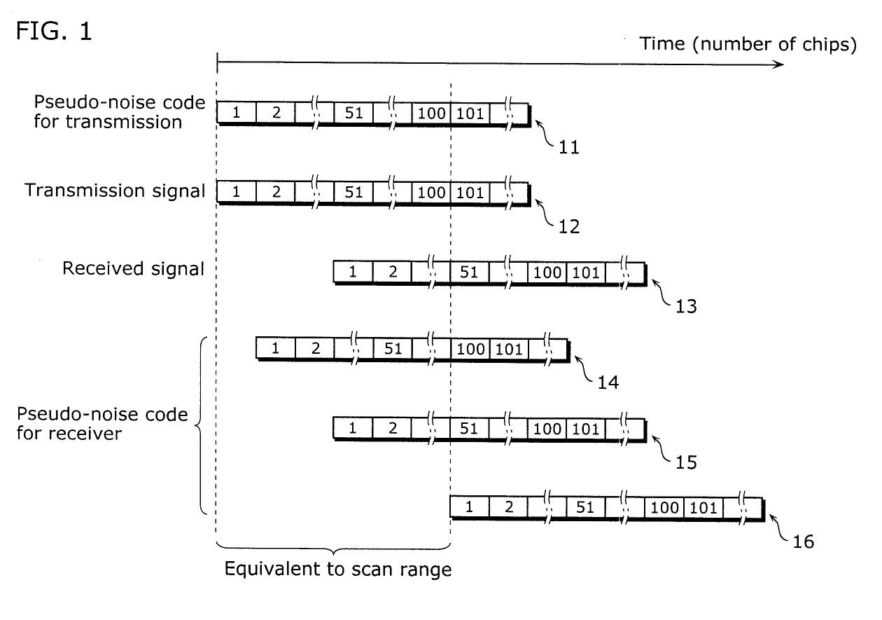

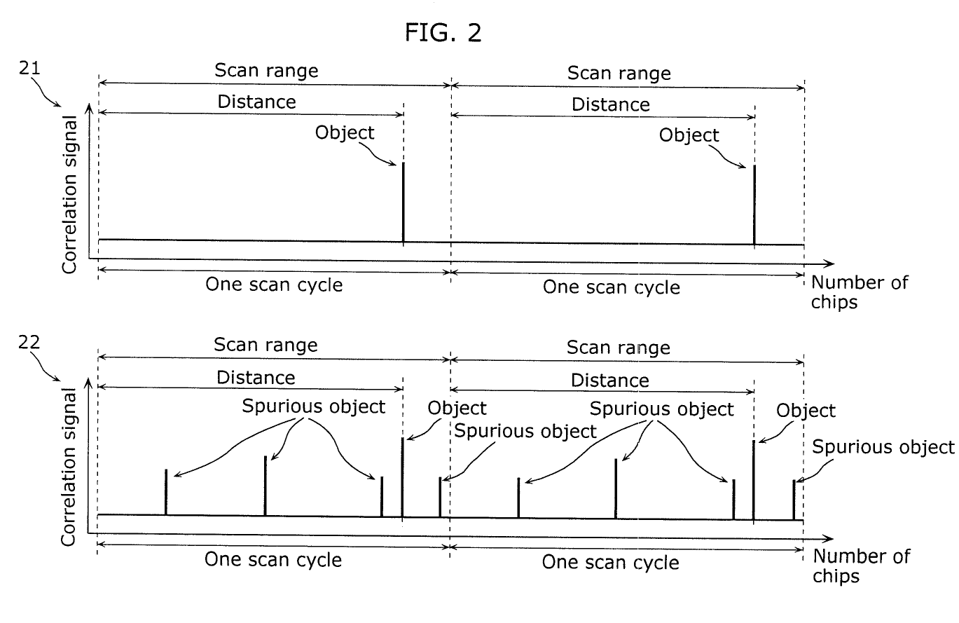

### DESCRIPTION OF THE PREFERRED EMBODIMENT

The following describes a preferred embodiment of the present invention with reference to the drawings.

First, the configuration of the spread spectrum radar apparatus according to the present embodiment shall be described.

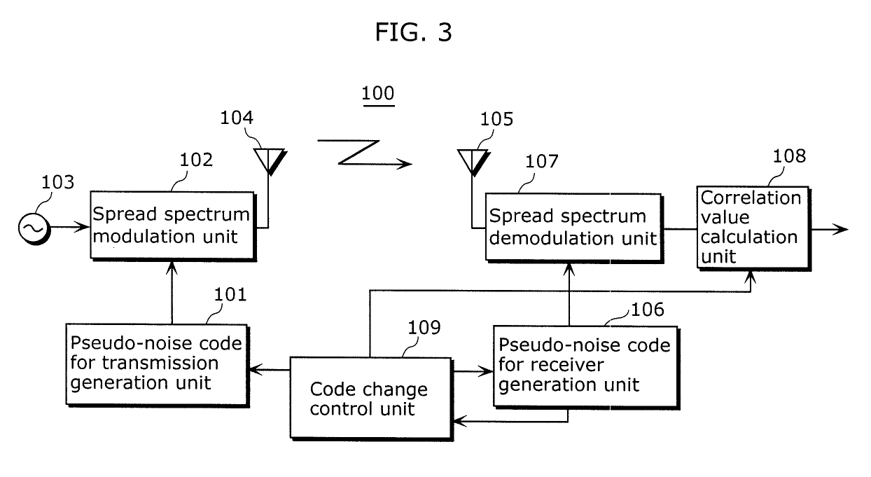

FIG. 3 is the diagram showing the configuration of the spread spectrum radar apparatus according to the present embodiment. As shown in FIG. 3, a spread spectrum radar apparatus 100 generates a broad-band signal by performing the spread spectrum modulation on a narrow-band carrier signal using a pseudo-noise code for transmission. The broad-band signal obtained by the spread spectrum modulation is transmitted as a radar wave. A reflected wave obtained through reflection of the transmitted radar wave off an object is received as a received signal. A correlation signal is generated by performing spread spectrum demodulation on the received signal using a pseudo-noise code for receiver. A presence or absence of the object, a distance to the object, and a relative speed to the object are calculated based on the correlation signal obtained by the spread spectrum demodulation. At this time, for example, the pseudo-noise code is changed into a different kind of the pseudo-noise code for every one cycle or plural cycles, with the scan cycle of the radar apparatus being the standard. An average value or integration value of an intensity of the correlation signal obtained by the spread spectrum demodulation is calculated based on the number of kinds of the changed pseudo-noise codes. This allows an influence of the alias signal causing the spurious object to be suppressed.

Here, as an example, the spread spectrum radar apparatus 100 includes: a pseudo-noise code for transmission generation unit 101; a spread spectrum modulation unit 102; a carrier signal source 103; a transmission antenna 104; a receiving antenna 105; a pseudo-noise code for receiver generation unit 106; a spread spectrum demodulation unit 107; a correlation value calculation unit 108; a code change control unit 109; and so on.

The pseudo-noise code for transmission generation unit 101 generates the pseudo-noise code for transmission and provides the generated pseudo-noise code for transmission for the spreading modulation unit 102. Furthermore, when a control signal that causes a pseudo-noise code to be changed into a different kind of the pseudo-noise code is outputted from the code change control unit 109, a pseudo-noise code for transmission is generated by changing a kind of the pseudo-noise code for transmission into a different kind of the pseudo-noise code for transmission. Here, the pseudo-noise code for transmission is, for example, a pseudo-noise code such as an M-sequence code and Gold-sequence code. Here, as an example, the M-sequence code with the superior autocorrelation property is assumed.

The spreading modulation unit 102 generates a broad-band signal by performing the spread spectrum modulation on (by spreading) a narrow-band signal provided by the carrier signal source 103, using the pseudo-noise code for transmission provided by the pseudo-noise code for transmission generation unit 101. The broad-band signal obtained by the spread spectrum modulation is transmitted through the transmission antenna 104.

The carrier signal source 103 generates the narrow-band signal (carrier wave) and provides the generated narrow-band signal for the spreading modulation unit 102.

The pseudo-noise code for receiver generation unit 106 generates the pseudo-noise code for receiver and provides the generated pseudo-noise code for receiver for the spread spectrum demodulation unit 107. Moreover, when the control signal that causes the pseudo-noise code to be changed into a different kind of the pseudo-noise code is outputted from the code change control unit 109, a pseudo-noise code for receiver is generated by changing a kind of the pseudo-noise code for receiver into a different kind of the pseudo-noise code for receiver. Further, a trigger signal is generated for each time which is more than a cycle of the pseudo-noise code and less than half of an update time for the radar apparatus, and the generated trigger signal is outputted to the code change control unit 109. Here, as an example, it is assumed that the trigger signal is outputted from the pseudo-noise code for receiver generation unit 106 for every one scan cycle. Here, the pseudo-noise code for receiver is a pseudo-noise code which is a time-delayed pseudo-noise code for transmission. That is to say, the pseudo-noise code for receiver is a pseudo-noise code that is of the same kind as the pseudo-noise code for transmission and a time-delayed pseudo-noise with respect to the pseudo-noise code for transmission.

It should be noted that the pseudo-noise code for receiver generation unit 106 may be configured to receive the pseudo-noise code for transmission outputted from the pseudo-noise code for transmission generation unit 101, make it time-delayed, and output it.

The spread spectrum demodulation unit 107 generates the correlation signal by performing the spread spectrum demodulation on (by despreading) the received signal received through the receiving antenna 105, using the pseudo-noise code for receiver provided by the pseudo-noise code for receiver generation unit 106. The correlation signal obtained by the spread spectrum demodulation is outputted to the correlation value calculation unit 108. Here, when the received signal and the pseudo-noise code for receiver are in the synchronized state, an intensity of the correlation signal is equivalent to a code length of the pseudo-noise code for receiver, and when they are in the asynchronous state, the intensity of the correlation signal is −1.

The correlation value calculation unit 108 calculates the average value or the integration value of the intensity of the correlation signal. It should be noted that, in the case where the predetermined time at which the pseudo-noise code is changed is longer than a scan cycle, the calculation unit averages or integrates correlation values in one or more scans performed until the predetermined time. On the other hand, in the case where the predetermined time is shorter than the scan cycle, since the averaging or integrating of correlation values in one scan cycle is performed, data in which correlation values demodulated by plural kinds of pseudo-noise codes are mixed in one scan cycle is to be calculated.

The code change control unit 109 outputs the control signal that causes the pseudo-noise code for transmission and the pseudo-noise code for receiver into a different kind of the pseudo-noise codes respectively for each predetermined time. For example, upon receiving the trigger signal outputted from the pseudo-noise code for receiver generation unit 106 for each scan cycle, the control signal that causes the pseudo-noise code to be changed is outputted, for every one scan cycle or plural scan cycles of the radar apparatus, to the pseudo-noise code for transmission generation unit 101 and the pseudo-noise code for receiver generation unit 106. Further, the control signal that causes the pseudo-noise code to be changed is outputted to the correlation value calculation unit 108.

Next, a configuration of the pseudo-noise code for transmission generation unit 101 shall be described.

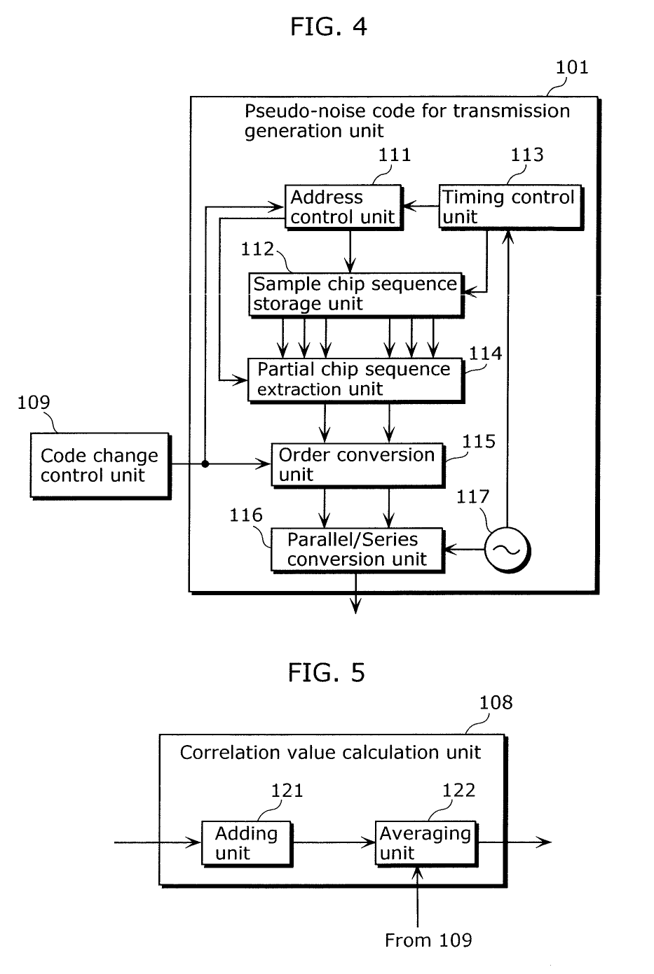

FIG. 4 is a diagram showing the configuration of the pseudo-noise code for transmission generation unit 101 according to the present embodiment.

As shown in FIG. 4, the pseudo-noise code for transmission generation unit 101 includes: an address control unit 111; a sample chip sequence storage unit 112; a timing control unit 113; a partial chip sequence extraction unit 114; an order conversion unit 115; a parallel/series conversion unit 116; a clock generation unit 117; and so on.

The address control unit 111 generates an address with which a sample chip sequence and a partial chip sequence to be read is specified, according to a timing signal provided by the timing control unit 113. At this time, the address with which the sample chip sequence to be read is specified is generated according to the control signal outputted from the code change control unit 109. Then, the generated address is outputted to the sample chip sequence storage unit 112. Here, the address is identification information assigned to each sample chip sequence of plural sample chip sequences stored in the sample chip sequence storage unit 112.

The sample chip sequence storage unit 112 stores the plural chip sequences making up of the pseudo-noise code for transmission. When the address is outputted from the address control unit 111, the sample chip sequence specified by the outputted address is selected from the stored plural sample chip sequences. The selected sample chip sequence is outputted through parallel transmission according to the timing signal provided by the timing control unit 113. Here, the sample chip sequence is a group of the plural chips having data bus width of the largest size at an output side of the sample chip sequence storage unit 112.

The timing control unit 113 generates the timing signal at the second frequency lower than the first frequency and provides the generated timing signal for the address control unit 111 and the sample chip sequence storage unit 112. It should be noted that the timing signal may be generated at the first frequency.

The partial chip sequence extraction unit 114 extracts a predetermined number of chips as a partial chip sequence from the sample chip sequence outputted from the sample chip sequence storage unit 112. At this time, a part to be extracted, as the partial chip sequence, from the sample chip sequence outputted from the sample chip sequence storage unit 112 is shifted according to the control signal outputted from the address control unit 111. Then, the extracted partial chip sequence is outputted. Here, as an example, the number of chips in the partial chip sequence is assumed as eight. It should be noted that, instead of eight chips, the number of chips may be 16 or the like.

The order conversion unit 115 maintains or reverses an order of the chips in the partial chip sequence outputted from the partial chip sequence extraction unit 114 according to the control signal outputted from the code change control unit 109. The partial chip sequence having the order of the chips maintained or a partial chip sequence which is a chip sequence obtained by reversing the order of the chips is outputted to the parallel/series conversion unit 116. It should be noted that, in the case where sufficient kinds of codes for changing the kinds of the pseudo-noise codes are stored in the sample chip sequence storage unit 112, the order conversion unit 115 may be unprovided. In the case where the order conversion unit 115 is unprovided, the partial chip sequence outputted from the partial chip sequence extraction unit 114 is outputted to the parallel/series conversion unit 116, with its order of the chips being maintained.

The parallel/series conversion unit 116 outputs, one at a time, the chips in the partial chip sequence outputted from the order conversion unit 115 through serial transmission, according to a clock signal provided by the clock generation unit 117. The clock generation unit 117 generates the clock signal at the first frequency, provides the generated clock signal for the parallel/series conversion unit 116, and drives the parallel/series conversion unit 116.

It should be noted that, since the pseudo-noise code for receiver generation unit 106 has the same configuration as the pseudo-noise code for transmission generation unit 101, it is not described here. However, the address control unit (the same structure as the address control unit 111 in FIG. 4) of the pseudo-noise code for receiver generation unit 106 outputs the trigger signal for each time which is more than the pseudo-noise code cycle and less than half of the update time for the radar apparatus. But, it is needless to say that generating the trigger signal per scan cycle makes the calculation and configuration in the code change control unit 109 and the correlation value calculation unit 108 simpler. In addition, since the pseudo-noise code for receiver generation unit 106 has the same configuration as the pseudo-noise code for transmission generation unit 101, the trigger signal may be outputted from the pseudo-noise code for transmission generation unit 101. However, it goes without saying that outputting the trigger signal from the pseudo-noise code for receiver generation unit 106 necessary for radar scan reduces an amount of the calculation more.

Next, a configuration of the correlation value calculation unit 108 shall be described. FIG. 5 is a diagram showing the configuration of the correlation value calculation unit 108 according to the present embodiment. As shown in FIG. 5, here, as an example, the correlation value calculation unit 108 includes an adding unit 121 and an averaging unit 122, and calculates the average value of the intensity of the correlation signal. This allows the peak induced by the alias signal causing the spurious object to be suppressed and the peak induced by the received signal to be easily extracted. It should be noted that, in the case of calculating the integration value of the intensity of the correlation signal, it is needless to say that the correlation value calculation unit 108 is made up of components which calculate the integration value.

The adding unit 121 adds the correlation signal outputted from the spread spectrum demodulation unit 107 as a correlation value. The averaging unit 122 averages the intensity of the correlation signal added by the adding unit 121 with the number of kinds of the pseudo-noise codes generated by the pseudo-noise code for transmission generation unit 101 and the pseudo-noise code for receiver generation unit 106. At this time, concerning the number of kinds of the generated pseudo-noise codes, they may be stored inside of the averaging unit 122 and may be obtained from the code change control unit 109.

It should be noted that, even when the correlation value calculation unit 108 is made up of only the adding unit 121, the same effect can be gained.

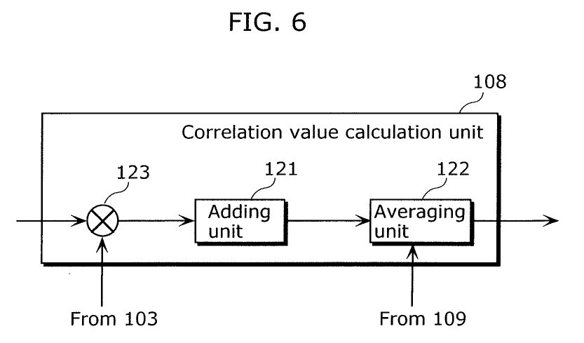

Furthermore, another example different from the configuration of the correlation value calculation unit 108 according to the present invention shown in FIG. 5 is shown in FIG. 6. As shown in FIG. 6, a frequency conversion unit 123 may be added. The frequency conversion unit 123 converts the correlation signal outputted from the spread spectrum demodulation unit 107 into a signal having a frequency lower than the carrier signal, using the carrier signal outputted from the carrier signal source 103. The correlation value may be calculated using this converted signal. It should be noted that the frequency conversion unit 123 may change the correlation signal into a signal having a difference between the frequency of the carrier signal and that of a local signal, using, instead of the carrier signal, the local signal having the frequency different from the carrier signal.

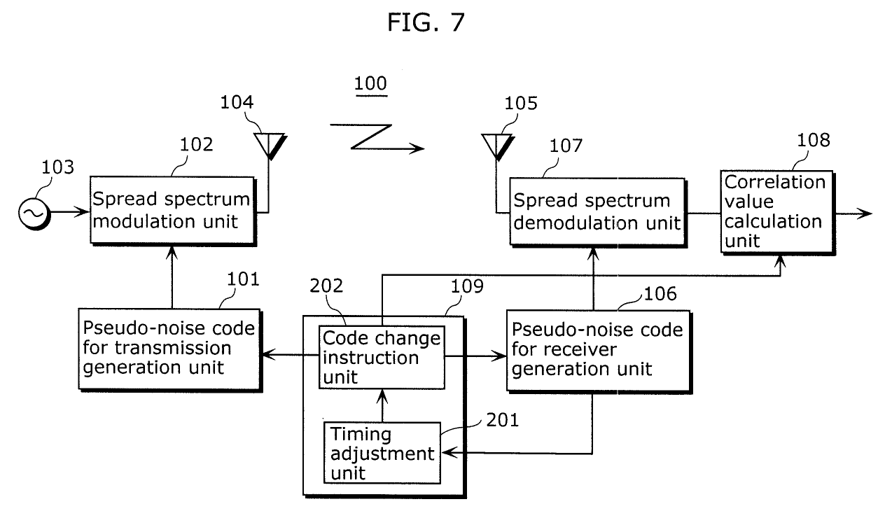

Next, a configuration of the code change control unit 109 shall be described. FIG. 7 is a diagram showing the configuration of the code change control unit 109 according to the present embodiment. As shown in FIG. 7, the code change control unit 109 includes: a timing adjustment unit 201 which adjusts a timing for changing the pseudo-noise code for transmission and the pseudo-noise code for receiver according to the trigger signal outputted from the pseudo-noise code for receiver generation unit 106; and a code change instruction unit 202 which issues an instruction for changing the pseudo-noise code generated from the pseudo-noise code for transmission generation unit 101 and the pseudo-noise code generated from the pseudo-noise code for receiver generation unit 106 into different kinds of the codes based on a timing signal outputted from the timing adjustment unit 201. The timing adjustment unit 201 receives the trigger signal outputted from the pseudo-noise code for receiver generation unit 106 for each scan cycle, and outputs, to the code change instruction unit 202, the timing signal that determines a timing for changing the pseudo-noise codes for every one scan cycle or plural scan cycles. The code change instruction unit 202 receives the timing signal, and outputs a control signal that instructs the pseudo-noise code for transmission generation unit 101 and the pseudo-noise code for receiver generation unit 106 to change the pseudo-noise codes into a different kind of the pseudo-noise codes.

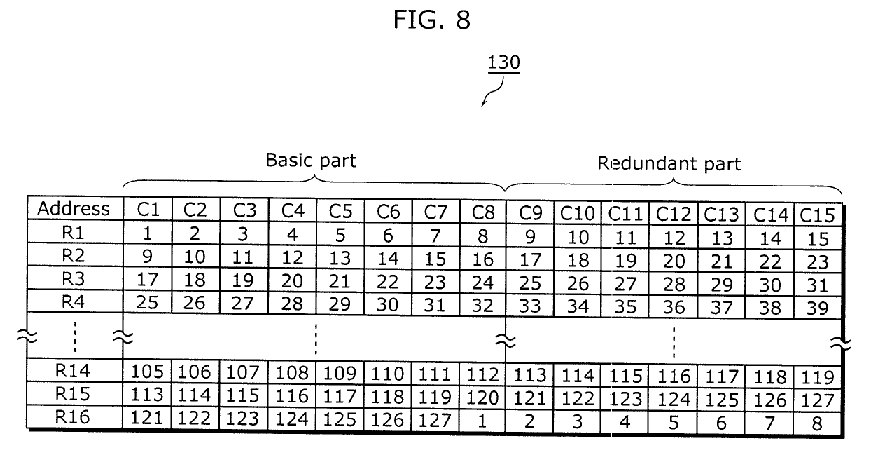

Next, the sample chip sequence stored in the sample chip sequence storage unit 112 shall be described. FIG. 8 is a diagram showing an example of the sample chip sequence stored in the sample chip sequence storage unit 112 according to the present embodiment. As shown in FIG. 8, here, as an example, a cycle of the M-sequence code is assumed as 127. It is assumed that one set of the sample chip sequence which can make up of pseudo-noise codes of a code cycle 127 is stored in the sample chip sequence storage unit 112. It should be noted that a mapping table 130 is a table showing storage regions in which the sample chip sequence is stored.

As shown in the mapping table 130, the sample chip sequence storage unit 112 stores the sample chip sequences for each of addresses R1 to R16. Each sample chip sequence is made up of a basic part of eight higher chips (C1 to C8) and a redundant part of seven lower chips (C9 to C15). The redundant part is same as the basic part of seven higher chips in a sample chip sequence of a next address.

For example, chips 1 to 15 are stored, in order, in to C15 in a storage region of the address R1. Chips 9 to 23 are stored, in order, in C1 to C15 in a storage region of the address R2. Here, since the M-sequence code (the code cycle: 2⁷−1=127) is used as the pseudo-noise code, a space of one chip becomes vacant in the basic part in a storage region of the address R16. Consequently, the chip 1 and its subsequent chips are stored, in order, in the vacated part (R16: C8) onwards again.

Next, that the alias signal causing the spurious object is suppressed in the spread spectrum radar apparatus 100 shall be described.

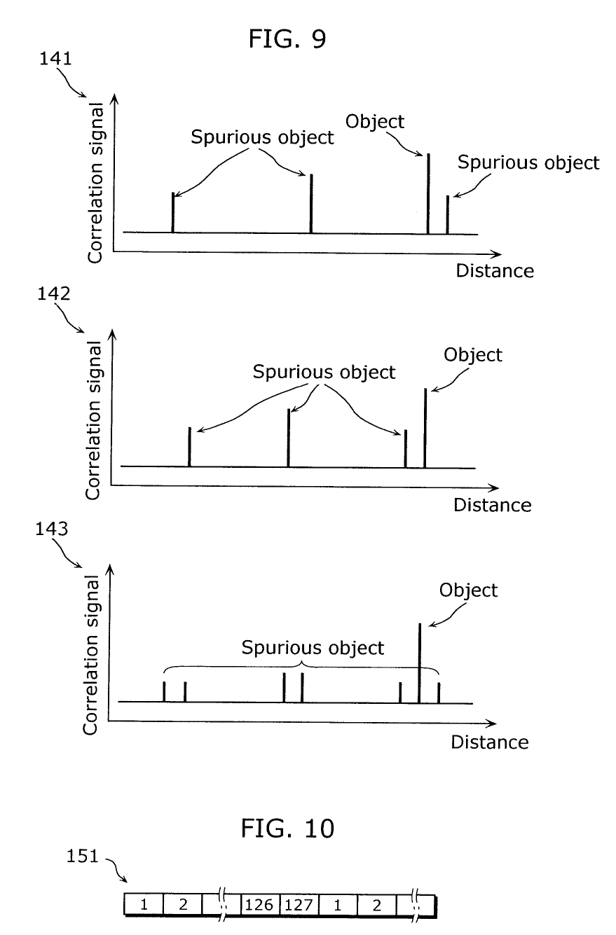

FIG. 9 is a diagram showing the situation where the alias signal causing the spurious object is suppressed in the spread spectrum radar apparatus 100 according to the present embodiment. As shown in FIG. 9, here, as an example, the first kind pseudo-noise code and the second kind pseudo-noise code are used as the pseudo-noise code for transmission and the pseudo-noise code for receiver. Here, the second kind pseudo-noise code is a pseudo-noise code that is different from the first kind pseudo-noise code in kind. Specifically, the second kind pseudo-noise code is a pseudo-noise code having reversely-ordered chips of the first kind pseudo-noise code. It should be noted that, since the second kind pseudo-noise code is the pseudo-noise code having the reversely-ordered chips of the first kind pseudo-noise code, it is possible to reduce processing loads put on the pseudo-noise code for transmission generation unit 101 and the pseudo-noise code for receiver generation unit 106. It should be noted that a different kind of the pseudo-noise code may be used without making the pseudo-noise code having the reversely-ordered chips of the first kind pseudo-noise code the second kind pseudo-noise code.

The correlation signal outputted from the correlation value calculation unit 108 is inputted to a judgment unit (not illustrated) which judges a presence or absence of the object. The judgment unit judges that the object is absent in a distance equivalent to the case where an intensity of a correlation signal to be inputted is less than a predetermined threshold value.

Generally speaking, in the case of using the M-sequence code as the pseudo-noise code, the reflected wave obtained through reflection of the radar wave off the object, that is, only the peak induced by the received signal, is supposed to appear in the correlation signal. However, in fact, as in graphs 141 and 142 in FIG. 9, peaks induced by the alias signal causing the spurious object appear in the correlation signal, in addition to the peak induced by the received signal. Further, when the kinds of the pseudo-noise codes are different, the alias signals changes accordingly. For example, the kinds of the pseudo-noise codes are changed per scan cycle of the radar apparatus, such as one cycle or plural cycles. The intensity of the correlation signal is averaged or integrated by the number of kinds of the pseudo-noise codes generated by the pseudo-noise code for transmission generation unit 101 and the pseudo-noise code for receiver generation unit 106. In this case, since the peaks induced by the alias signals appear at different locations according to the kinds of the pseudo-noise codes, they are suppressed by averaging or integration. On the other hand, in the case where a detection object stands still, since the peak induced by the received signal appears at the same location regardless of the kinds of the pseudo-noise codes, it is not suppressed by averaging or integration and a difference with the peaks induced by the alias signals becomes remarkable. Based on the above points, as shown by graph 143 in FIG. 9, it is possible to suppress the peaks induced by the alias signals and to easily extract the peak induced by the received signal. Consequently, it is possible to prevent the misidentification of the presence of object.

Here, as shown by the graph 141, the intensity of the correlation signal is the intensity of the correlation signal outputted from the spread spectrum demodulation unit 107 to the correlation value calculation unit 108, when the first kind pseudo-noise code is used for the pseudo-noise code for transmission and the pseudo-noise code for receiver.

The intensity of the correlation signal shown by the graph 142 is the intensity of the correlation signal outputted from the spread spectrum demodulation unit 107 to the correlation value calculation unit 108, when the second kind pseudo-noise code is used for the pseudo-noise code for transmission and the pseudo-noise code for receiver.

The intensity of the correlation signal shown by the graph 143 is a result obtained as following. The intensity of the correlation signal shown by the graph 141 and the intensity of the correlation signal shown by the graph 142 are added, and the addition is divided by the number of kinds of the pseudo-noise codes generated by the pseudo-noise code for transmission generation unit 101 and the pseudo-noise code for receiver generation unit 106. Here, since two kinds of the pseudo-noise codes are generated, the result is obtained by dividing the addition by two.

It should be noted that it is possible to further reduce the influence of the alias signal shown in the graph 143 by increasing the number of times for changing the kinds of the pseudo-noise codes and by obtaining the average value or the integration value with respect to the intensity of the correlation signal that is outputted from the spread spectrum demodulation unit 107.

Here, a case where the control signal that causes the kind of the pseudo-noise code to be changed into another kind of the pseudo-noise code is outputted from the code change control unit 109 for one scan cycle or plural cycles of the radar apparatus and the first kind pseudo-noise code is changed into the second kind pseudo-noise code shall be described.

First, before the control signal that causes the kind of the pseudo-noise code to be changed into another kind of the pseudo-noise code is outputted from the code change control unit 109, the pseudo-noise code for transmission generation unit 101 has generated the first kind pseudo-noise code.

FIG. 10 is a diagram showing the first kind pseudo-noise code outputted from the pseudo-noise code for transmission generation unit 101 according to the present embodiment. As shown in FIG. 10, the chips 1 to 127 are outputted from the pseudo-noise code for transmission generation unit 101 in ascending order (a first kind pseudo-noise code 151).

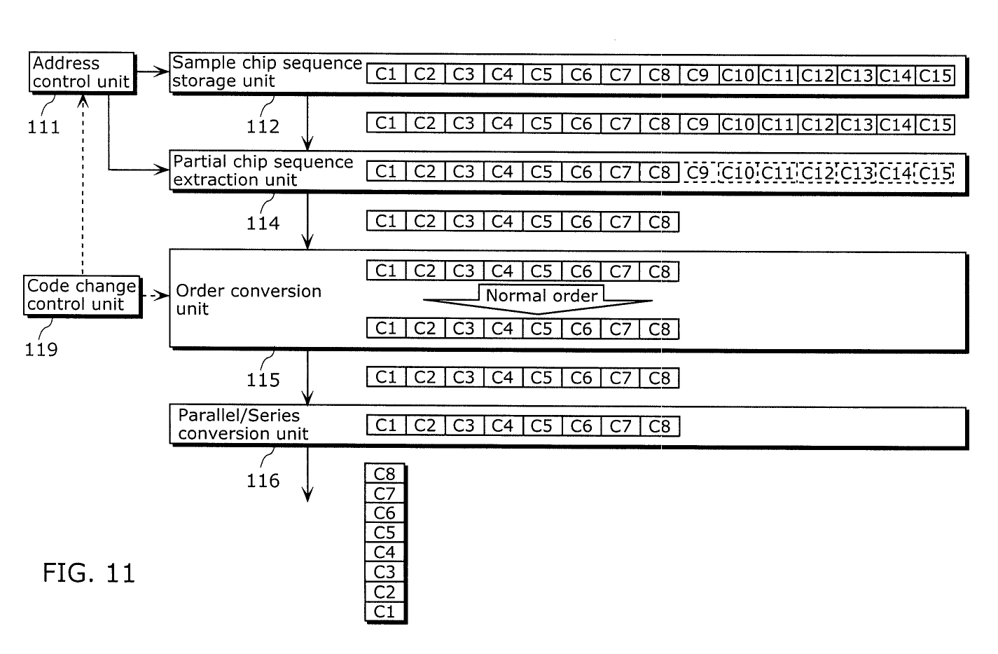

FIG. 11 is a diagram showing the flow at the time when the first kind pseudo-noise code is outputted from the pseudo-noise code for transmission generation unit 101 according to the present embodiment. As shown in FIG. 11, in this case, the code change control unit 109 does not output, to the address control unit 111 and the order conversion unit 115, the control signal that causes the kind of the pseudo-noise code to be changed into another kind of the pseudo-noise code. Along with this, the address control unit 111 generates the addresses R1 to R16 in ascending order. The partial chip sequence extraction unit 114 extracts, from the sample chip sequence outputted from the sample chip sequence storage unit 112, eight chips following the highest chip inclusive as the partial chip sequence. The order conversion unit 115 outputs, in normal order, the partial chip sequence outputted from the partial chip sequence extraction unit 114.

Specifically, first, the address control unit 111 outputs the address R1 to the sample chip sequence storage unit 112.

The sample chip sequence storage unit 112 selects, from among stored plural sample chip sequences, a sample chip sequence (R1: C1 to C15) specified by the address R1 outputted from the address control unit 111. The selected sample chip sequence (R1: C1 to C15) is outputted.

The partial chip sequence extraction unit 114 extracts, from the sample chip sequence (R1: C1 to C15) outputted from the sample chip sequence storage unit 112, a chip sequence (R1: C1 to C8). The extracted chip sequence (R1: C1 to C8) is outputted as the partial chip sequence.

The order conversion unit 115 outputs, without change, the partial chip sequence (R1: C1 to C8) outputted from the partial chip sequence extraction unit 114. This is because the control signal that causes the kind of the pseudo-noise code to be changed has not been outputted from the code change control unit 109.

The parallel/series conversion unit 116 outputs, one at a time, in ascending order, the chips in the partial chip sequence (R1: C1 to C8) outputted from the order conversion unit 115.

Consequently, the chips 1 up to 8 are outputted, one at a time, from the parallel/series conversion unit 116.

Likewise, the address control unit 111 outputs, in ascending order, an address Rn (n is a natural number between 2 and 16) to the sample chip sequence storage unit 112. This allows the chips 9 up to 127 and the chip 1 to be outputted, one at a time, from the parallel/series conversion unit 116. It should be noted that, in the case of continuously outputting, a part to be extracted by the partial chip sequence extraction unit 114 is shifted lower by one chip, and the address Rn (n is a natural number between 1 and 16) is outputted, in ascending order, to the sample chip sequence storage unit 112. At this time, the following partial chip sequences are extracted by the partial chip sequence extraction unit 114: (the second round) partial chip sequence (R1 to R16: C2 to C9); (the third round) partial chip sequence (R1 to R16: C3 to C10); (the fourth round) partial chip sequence (R1 to R16: C4 to C11); (the fifth round) partial chip sequence (R1 to R16: C5 to C12); (the sixth round) partial chip sequence (R1 to R16: C6 to C13); (the seventh round) partial chip sequence (R1 to R16: C7 to C14); (the eighth round) partial chip sequence (R1 to R15: C8 to C15); and (the ninth round) the same partial chip sequence as the first round (R1 to R16: C1 to C8). After that, rounds subsequent to the tenth round go back to the round subsequent to the second round. This allows chips subsequent to the chip 1 to be outputted, one at a time, from the parallel/series conversion unit 116.

Next, after the control signal that causes the kind of the pseudo-noise code to be changed into another kind of the pseudo-noise code is outputted from the code change control unit 109, the pseudo-noise code for transmission generation unit 101 outputs the second kind pseudo-noise code.

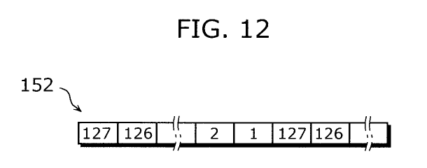

FIG. 12 is a diagram showing the second kind pseudo-noise code outputted from the pseudo-noise code for transmission generation unit 101 according to the present embodiment. As shown in FIG. 12, the chips 127 to 1 are outputted from the pseudo-noise code for transmission generation unit 101 in descending order (a second kind pseudo-noise code 152).

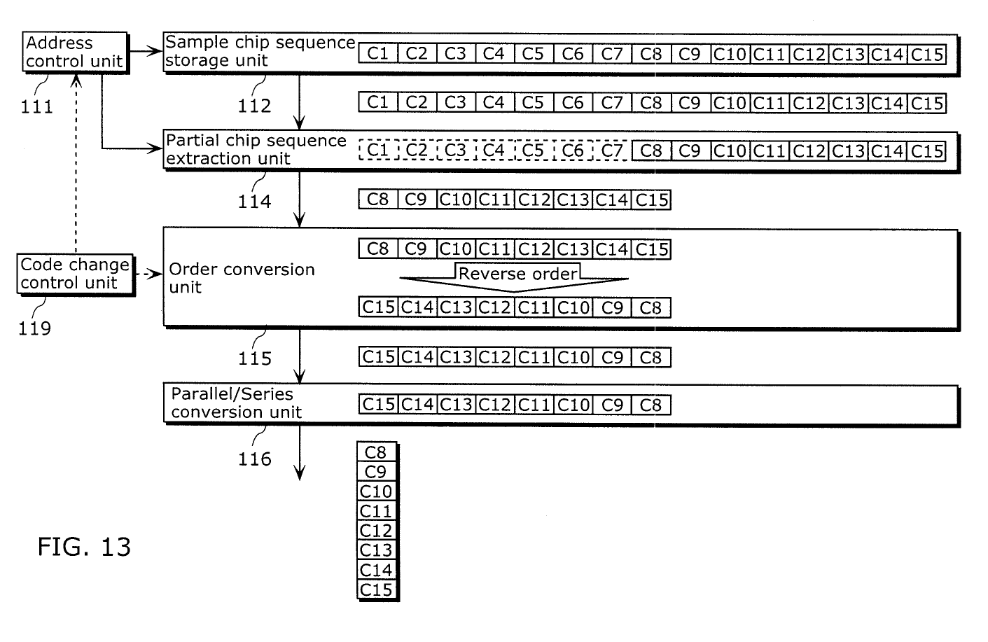

FIG. 13 is a diagram showing the flow at the time when the second kind pseudo-noise code is outputted from the pseudo-noise code for transmission generation unit 101 according to the present embodiment. As shown in FIG. 13, in this case, the code change control unit 109 outputs, to the address control unit 111 and the order conversion unit 115, the control signal that causes the kind of the pseudo-noise code to be changed into another kind of the pseudo-noise code. Along with this, the address control unit 111 generates the addresses R15 to R1 in descending order. The partial chip sequence extraction unit 114 extracts, from the sample chip sequence outputted from the sample chip sequence storage unit 112, eight chips preceding the lowest chip inclusive as the partial chip sequence. The order conversion unit 115 outputs the partial chip sequence outputted from the partial chip sequence extraction unit 114 in reverse order. After generating the addresses R15 to R1 in descending order, the address control unit 111 generates the address R16. A part to be extracted from the sample chip sequence outputted from the sample chip sequence storage unit 112 as the partial chip sequence by the partial chip sequence extraction unit 114 is shifted higher by one chip. The order conversion unit 115 reverses the order of the chips in the partial chip sequence outputted from the partial chip sequence extraction unit 114.

Specifically, first, the address control unit 111 outputs the address R15 to the sample chip sequence storage unit 112.

The sample chip sequence storage unit 112 selects, from among the stored plural sample chip sequences, a sample chip sequence (R15: C1 to C15) specified by the address R15 outputted from the address control unit 111. The selected sample chip sequence (R15: C1 to C15) is outputted.

The partial chip sequence extraction unit 114 extracts, from the sample chip sequence (R15: C1 to C15) outputted from the sample chip sequence storage unit 112, a chip sequence (R15: C8 to C15). The extracted chip sequence (R15: C8 to C15) is outputted as the partial chip sequence.

The order conversion unit 115 reverses the order of the chips in the partial chip sequence outputted from the partial chip sequence extraction unit 114 and outputs it. This is because the control signal that causes the kind of the pseudo-noise code to be changed has been outputted from the code change control unit 109.

The parallel/series conversion unit 116 outputs, one chip at a time, in descending order, the partial chip sequence (R15: C15 to C8) outputted from the order conversion unit 115.

As a result, the chips 127 up to 120 are outputted, one at a time, from the parallel/series conversion unit 116.

Likewise, the address control unit 111 outputs, in descending order, an address Rn (n is a natural number between 1 and 14) to the sample chip sequence storage unit 112. This allows the chips 119 up to 8 to be outputted, one at a time, from the parallel/series conversion unit 116. Then, the part to be extracted by the partial chip sequence extraction unit 114 is shifted higher by one chip, and the address R16 is outputted to the sample chip sequence storage unit 112. This allows the chips 7 up to 1 and the chip 127 to be outputted, one at a time, from the parallel/series conversion unit 116. It should be noted that, in the case of continuously outputting, the address Rn (n is a natural number between 1 and 16) is outputted, in descending order, to the sample chip sequence storage unit 112. At this time, the following partial chip sequences are extracted by the partial chip sequence extraction unit 114: (the second round) partial chip sequence (R16 to R1: C14 to C7); (the third round) partial chip sequence (R16 to R1: C13 to C6); (the fourth round) partial chip sequence (R16 to R1: C12 to C5); (the fifth round) partial chip sequence (R16 to R1: C11 to C4); (the sixth round) partial chip sequence (R16 to R1: C10 to C3); (the seventh round) partial chip sequence (R16 to R1: C9 to C2); (the eighth round) partial chip sequence (R16 to R1: C8 to C1); and (the ninth round) the same partial chip sequence as the first round (R15 to R1: C15 to C8). After that, the rounds subsequent to the tenth round go back to the round subsequent to the second round. This allows chips subsequent to the chip 127 to be outputted, one at a time, from the parallel/series conversion unit 116.

As stated above, the spread spectrum radar apparatus 100 according to the present embodiment changes the kind of pseudo-noise code for every one scan cycle or plural cycles, and averages or integrates the correlation signal with the number of the kinds of the generated pseudo-noise codes. This allows the influence of the alias signal causing the spurious object to be suppressed. Furthermore, the address control unit 111, the partial chip sequence extraction unit 114, and the order conversion unit 115 reverse the order of the chips in the pseudo-noise codes. This allows the different kinds of the pseudo-noise codes to be outputted without separately storing a set of the sample chip sequence for each kind of the pseudo-noise codes.

Although the spread spectrum radar apparatus of the present invention is described above based on the embodiment, the present invention is not limited to the embodiment. As long as the gist of the present invention is not departed from, the present embodiment to which various modifications conceived by a person with an ordinary skill in the art are applied is also included in the scope of the present invention.

For example, it is possible to output the different kinds of the pseudo-noise codes by interchanging addresses in the address control unit 111 or by shifting the part to be extracted in the partial chip sequence extraction unit 114. In addition, since it is possible to output chips at high chip rate, the distance resolution of the spread spectrum radar apparatus 100 can be improved.

It should be noted that, instead of the M-sequence code, other sequence codes with the inferior autocorrelation property, such as the Gold-sequence code, may be used as the pseudo-noise code. In this case also, it is possible that, while the spread spectrum radar apparatus 100 is changing the kinds of the pseudo-noise codes, the correlation value calculation unit 108 adds the intensity of the correlation signal outputted from the spread spectrum demodulation unit 107 and averages or integrates the addition with the number of the kinds of the generated pseudo-noise codes.

It should be noted that, when changing the kind of the pseudo-noise code into another kind of the pseudo-noise code, other than reversing the order of the chips in the pseudo-noise code, the phase of the pseudo-noise code may be shifted.

It should be noted that, although only the set of the chip sequences making up of the first kind pseudo-noise code is stored in the sample chip sequence storage unit 112, plural kinds of sets of the sample chip sequences making up of other kind of the pseudo-noise code may be stored in it. Moreover, a set of the sample chip sequences making up of the second kind pseudo-noise code may be stored there.

It should be noted that the control signal outputted from the code change control unit 109 may be a signal which acts as a trigger to change the kind of the pseudo-noise code into another kind of the pseudo-noise code, a signal which specifies whether or not the kind of the pseudo-noise code is to be changed, or a signal which identifies the kind of the pseudo-noise code. Additionally, there is no need to change the kind of the pseudo-noise code into another kind of the pseudo-noise code for every scan cycle, and the kind of the pseudo-noise code may be changed, for example, for one-half scan cycle.

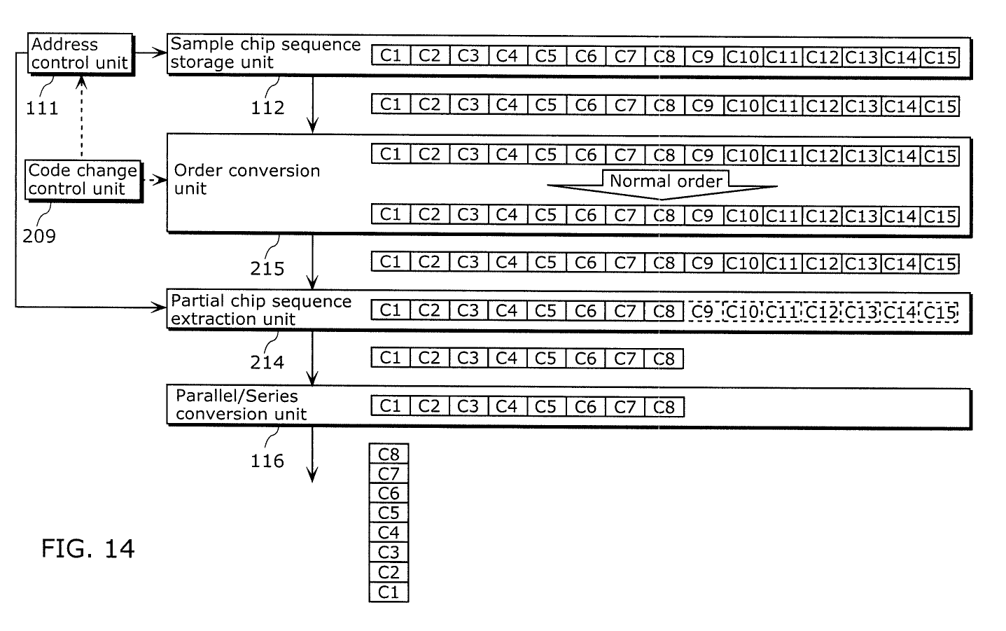

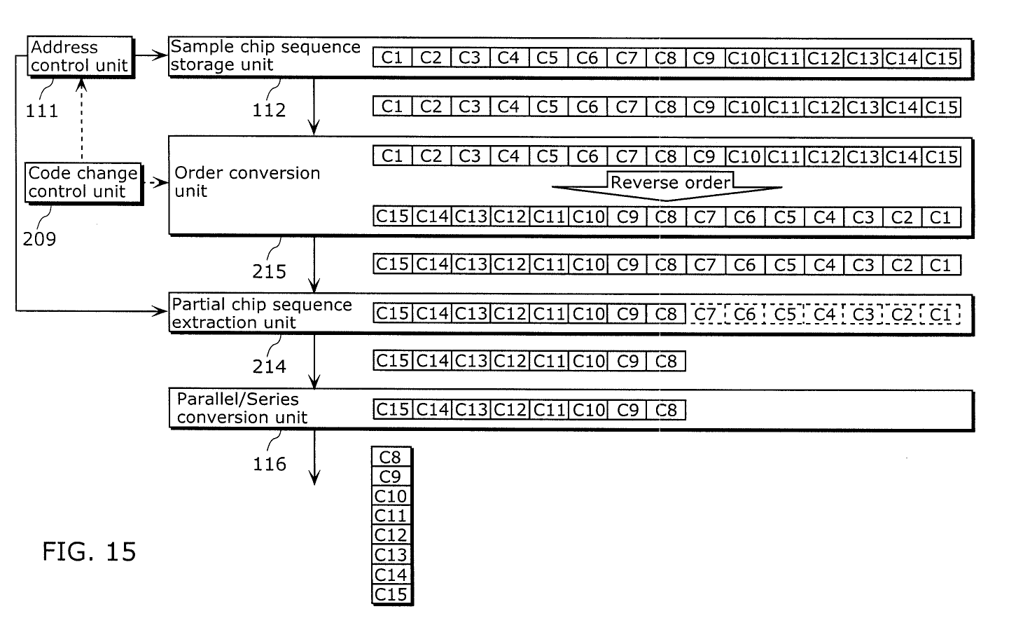

It should be noted that the order conversion unit 115 is connected to the partial chip sequence extraction unit 114 and the parallel/series conversion unit 116 in the pseudo-noise code for transmission generation unit 101 according to the present embodiment. However, instead of this, as shown in FIGS. 14 and 15, the order conversion unit 215 may be connected to the sample chip sequence storage unit 112 and the partial chip sequence extraction unit 214, and what is changed may be switched from the order of the chips in the partial chip sequence to the order of the chips in the sample chip sequence.

It should be noted that the time delay of the pseudo-noise code for receiver outputted from the pseudo-noise code for receiver generation unit 106 can be realized by selecting codes outputted by the address control unit 111 and the partial chip sequence extraction unit 114.

In addition, the pseudo-noise code for transmission generation unit 101 and the pseudo-noise code for receiver generation unit 106 may not use storage functions, such as the sample chip sequence storage unit 112, and may employ the code generation unit made up of shift registers.

It should be noted that, when the present invention is the radar apparatus using the spread spectrum scheme which suppresses the peak induced by the alias signal using the plural kinds of the pseudo-noise codes and which distinguishes the difference between the peak induced by the received signal and the suppressed peak of the alias signal, it is not limited to the above-mentioned configuration.

Although only some exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The present invention can be applied as the spread spectrum radar apparatus using the spread spectrum scheme or the like and, especially, as the spread spectrum radar apparatus which suppresses the alias signal generated other than the received signal or the like.

What is claimed is:

1. A spread spectrum radar apparatus which detects an object by transmitting and receiving a spread spectrum signal, said apparatus comprising:
a carrier wave generation unit operable to generate a carrier wave;
a code for transmission generation unit operable to generate a pseudo-noise code for transmission;
a spread spectrum modulation unit operable to perform spread spectrum modulation on the carrier wave using the pseudo-noise code for transmission;
a transmission unit operable to transmit, as a transmission signal, the carrier wave on which the spread spectrum modulation has been performed by said spread spectrum modulation unit;
a receiver unit operable to receive, as a received signal, a reflected wave obtained through reflection of the transmission signal off the object;
a code for receiver generation unit operable to generate a pseudo-noise code for receiver which is a time-delayed pseudo-noise code that is of a same kind as the pseudo-noise code for transmission;
a spread spectrum demodulation unit operable to perform spread spectrum demodulation on the received signal, using the pseudo-noise code for receiver, so as to output a correlation signal;
a control unit operable to control said code for transmission generation unit and said code for receiver generation unit so that the pseudo-noise code for transmission and the pseudo-noise code for receiver are changed into a different kind of pseudo-noise codes respectively at every predetermined time; and
a calculation unit operable to average or integrate an intensity of the correlation signal.

2. The spread spectrum radar apparatus according to claim 1,
wherein the predetermined time is a time equal to or more than a cycle of the pseudo-noise code for receiver or the pseudo-noise code for transmission and equal to or less than half of an update time for the spread spectrum radar apparatus.

3. The spread spectrum radar apparatus according to claim 2,
wherein said code for receiver generation unit is further operable to output a trigger signal for every cycle of the pseudo-noise code for receiver, every scan cycle, or every time the pseudo-noise code is time-delayed, and
said control unit is operable to control said code for transmission generation unit and said code for receiver generation unit by selecting the trigger signal for every predetermined time so that the pseudo-noise code for transmission and the pseudo-noise code for receiver are changed.

4. The spread spectrum radar apparatus according to claim 3,
wherein the predetermined time is time necessary for the trigger signal to be outputted one or more times, and
said control unit includes:
a timing adjustment unit operable to adjust a timing for changing the pseudo-noise code for transmission and the pseudo-noise code for receiver, by selecting the trigger signal one time at the predetermined time; and
a code change instruction issuance unit operable to issue, to said code for transmission generation unit, said code for receiver generation unit, and said calculation unit, an instruction to change the pseudo-noise code for transmission and the pseudo-noise code for receiver into the different kind of the pseudo-noise codes respectively, at the timing adjusted by said timing adjustment unit.

5. The spread spectrum radar apparatus according to claim 1,
wherein said control unit is operable to control said code for transmission generation unit and said code for receiver generation unit so that the pseudo-noise code for transmission and the pseudo-noise code for receiver are changed from a first kind pseudo-noise code into a second kind pseudo-noise code having an reversed order of chips of the first kind pseudo-noise code respectively at every predetermined time.

6. The spread spectrum radar apparatus according to claim 1, further comprising
a judgment unit operable to judge that the object is absent in a distance equivalent to the delay time at which the intensity of the correlation signal averaged or integrated by said calculation unit is equal to or less than a predetermined threshold value, so as to prevent misidentification of a presence of the object.

7. A misidentification prevention method for preventing the spread spectrum radar apparatus from misidentifying an object, said method comprising:
generating a carrier wave;
generating a pseudo-noise code for transmission;
performing spread spectrum modulation on the carrier wave using the pseudo-noise code for transmission;
transmitting, as a transmission signal, the carrier wave on which the spread spectrum modulation has been performed in said spreading;
receiving, as a received signal, a reflected wave obtained through reflection of the transmission signal off an object;
generating a pseudo-noise code for receiver which is a time-delayed pseudo-noise code that is of a same kind as the pseudo-noise code for transmission;
performing spread spectrum demodulation on the received signal in said receiving, using the pseudo-noise code for receiver, so as to output a correlation signal;
controlling the generation of the pseudo-noise code for transmission in said generating the pseudo-noise code for transmission and the generation of the pseudo-noise code for receiver in said generating the pseudo-noise code for receiver so that the first pseudo-noise code for transmission and the pseudo-noise code for receiver are changed into a different kind of pseudo-noise codes respectively at every predetermined time;
calculating an average or integration of an intensity of the correlation signal; and
judging that the object is absent in a distance equivalent to the delay time at which the intensity of the correlation signal averaged or integrated in said calculating is equal to or less than a predetermined threshold value, so as to prevent misidentification of a presence of the object.
